(19) United States
(12) Patent Application Publication
(10) Pub. No.: US 2013/0087549 A1
(43) Pub. Date: Apr. 11, 2013

(54) AQUARIUM HEATER

(71) Applicant: Yu-Chin WANG, Taipei (TW)

(72) Inventor: Yu-Chin WANG, Taipei (TW)

(21) Appl. No.: 13/268,046

(22) Filed: Oct. 7, 2011

(51) Int. Cl. H05B 3/78; H05B 1/00

(52) U.S. Cl. 219/489; 219/482

(57) ABSTRACT

An aquarium heater includes a top cover, a ceramic heater plate arranged at the bottom side of the top cover, a temperature control knob arranged at the top side of the top cover, a circuit controller arranged at the bottom side of the top cover for controlling the ceramic heater plate to generate one of a series of watts of heat energy subject to setting of the temperature control knob, a metal heat sink surrounding the ceramic heater plate, and an insulative housing tightly attached to the bottom side of the top cover around the metal heat sink.

### BACKGROUND OF THE INVENTION

1. Field of the Invention

The present invention relates to heating technology and more particularly, to an aquarium heater, which is practical for use in different sizes of aquariums

2. Description of the Related Art

When using an aquarium to keep water-dwelling plants and animals, a heater shall be used and set in the aquarium to warm the temperature of water in the aquarium, providing an optimal living environment for the water-dwelling plants and animals.

A conventional aquarium heater uses a resistor circuit in a glass tube for generating heat. Exemplars are seen in US Patent Publication number US-2010-0140256-A1 “High-power plastic heater for aquarium”, US Patent Publication number

US-2010-0140254-A1 “Aquarium heater”, U.S. Pat. No. 6,658,205 “Apparatus for adjusting temperature variation value correction of aquarium heating tube”.

FIG. 1 illustrates two different lengths of aquarium heaters according to the prior art. These two different lengths of aquarium heaters have the same structural design but adapted for use in different sizes of aquariums. The shorter one shown in FIG. 1(A) is adapted for use in a relatively smaller aquarium. The longer one shown in FIG. 1(B) is adapted for use in a relatively larger aquarium. Fabricating these two sizes of aquarium heaters require two different molding tools, increasing the cost. Further, using a resistor circuit to generate heat cannot achieve transient heating, i.e., the heating speed of an aquarium heater using a resistor circuit is slow.

### SUMMARY OF THE INVENTION

The present invention has been accomplished under the circumstances in view. It is one object of the present invention to provide an aquarium heater, which fits different sizes of aquariums.

To achieve this and other objects of the present invention, an aquarium heater comprises a top cover, a ceramic heater plate arranged at the bottom side of the top cover, a temperature control knob arranged at the top side of the top cover, a circuit controller arranged at the bottom side of the top cover for controlling the ceramic heater plate to generate one of a series of watts of heat energy subject to setting of the temperature control knob, a metal heat sink surrounding the ceramic heater plate, and an insulative housing tightly attached to the bottom side of the top cover around the metal heat sink.

Further, the circuit controller comprises a temperature sensing wire extending to the gap in between the ceramic heater plate and the metal heat sink for sensing a predetermined overheat temperature.

Thus, the aquarium heater has the advantages of (1) by means of using the ceramic heater plate to generate heat and a circuit design to control adjustment of the heating temperature of the ceramic heater plate, the aquarium heater fits different sizes of aquariums, saving the cost; (2) the circuit design of the circuit controller achieves anti-knocking control; (3) by means of using the ceramic heater plate to generate heat, the invention can achieve transient heating, eliminating the slow heating drawback of the conventional designs.

### BRIEF DESCRIPTION OF THE DRAWINGS

FIG. 1 illustrates two lengths of aquarium heaters according to the prior art.

FIG. 2 is an exploded view of an aquarium heater in accordance with the present invention.

FIG. 3 is a perspective view of the aquarium heater in accordance with the present invention.

FIG. 4 is a sectional view in the transverse direction of the aquarium heater in accordance with the present invention.

FIG. 5 is a sectional view in the longitudinal direction of the aquarium heater in accordance with the present invention.

FIG. 6 is a circuit block diagram of the aquarium heater in accordance with the present invention.

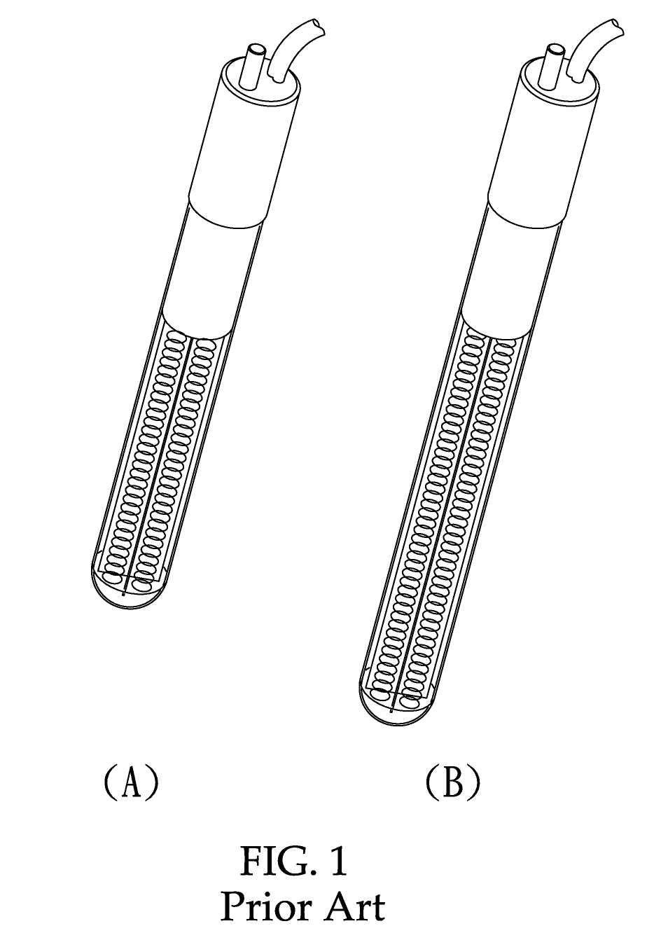

### DETAILED DESCRIPTION OF THE PREFERRED EMBODIMENT

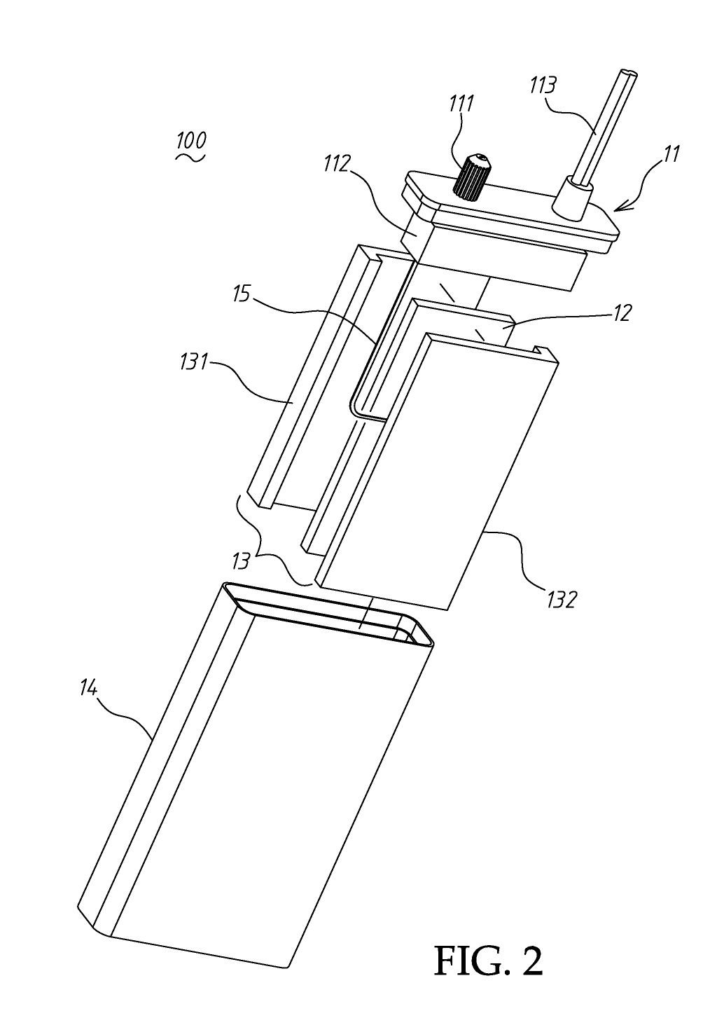

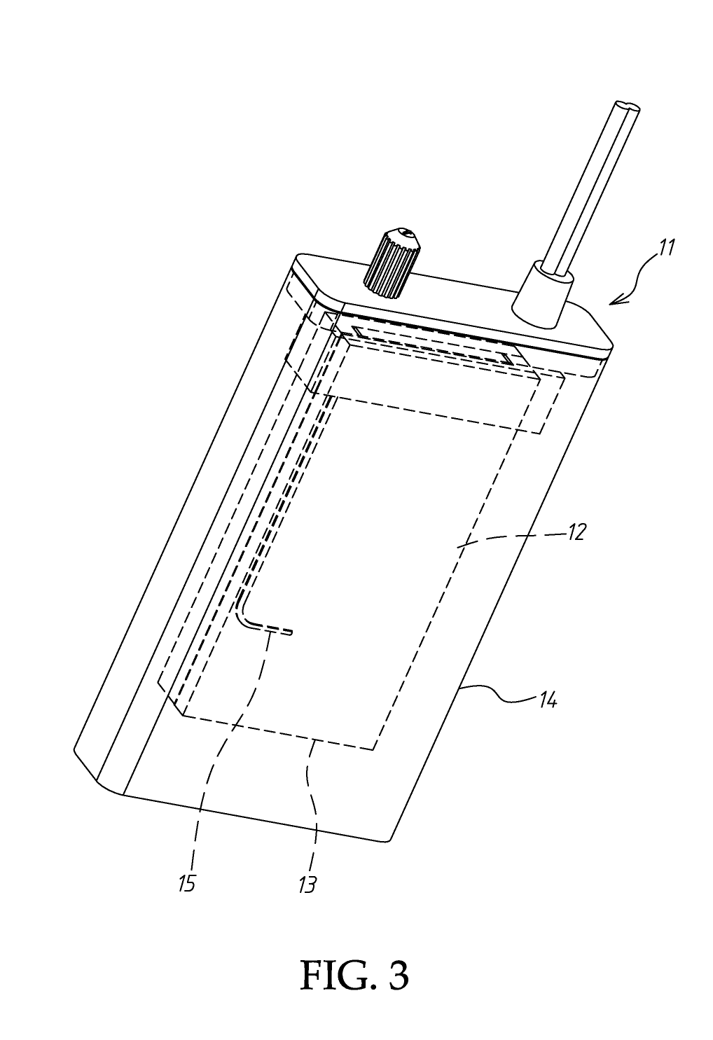

Referring to FIGS. 2 and 3, an aquarium heater 10 in accordance with the present invention is shown comprising a top cover 11, a ceramic heater plate 12, a metal heat sink 13, an insulative housing 14 and a temperature sensing wire 15.

The top cover 11 is made of an insulative material, having a temperature control knob 111 mounted at the top side thereof, a circuit controller 112 mounted at the bottom side thereof, and a power cord 113 electrically coupled with the circuit controller 112 and extending outside the top cover 11.

The ceramic heater plate 12 is arranged at the bottom side of the top cover 11 and electrically coupled with the circuit controller 112. Thus, the ceramic heater plate 12 is electrically controllable by the circuit controller 112 to generate one of a series of watts of heat energy to fit aquariums of different sizes.

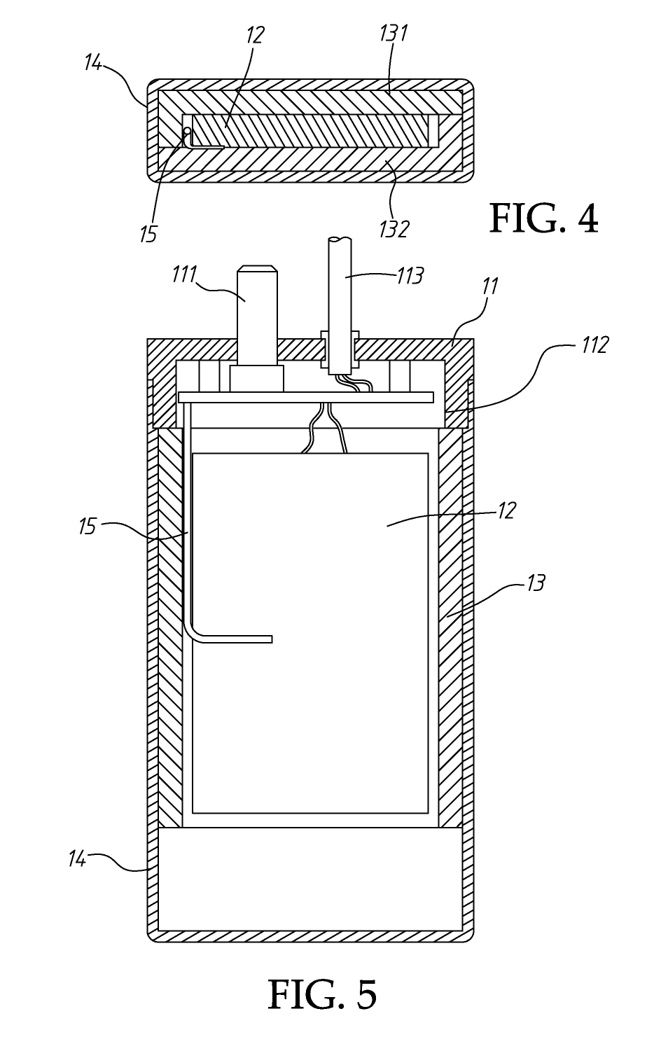

The metal heat sink 13 surrounds the ceramic heater plate 12. According to the present preferred embodiment, the metal heat sink 13 consists of a first heat sink member 131 and a second heat sink member 132, as shown in FIGS. 4 and 5.

The insulative housing 14 is tightly attached to the bottom side of the top cover 11 around the metal heat sink 13, as shown in FIGS. 4 and 5.

Further, the temperature sensing wire 15 extends from the circuit controller 112 to the gap between the ceramic heater plate 12 and the metal heat sink 13 for detecting overheating during operation of the ceramic heater plate 12. The temperature control knob 111 is operable by a user to set the heating temperature of the ceramic heater plate 12.

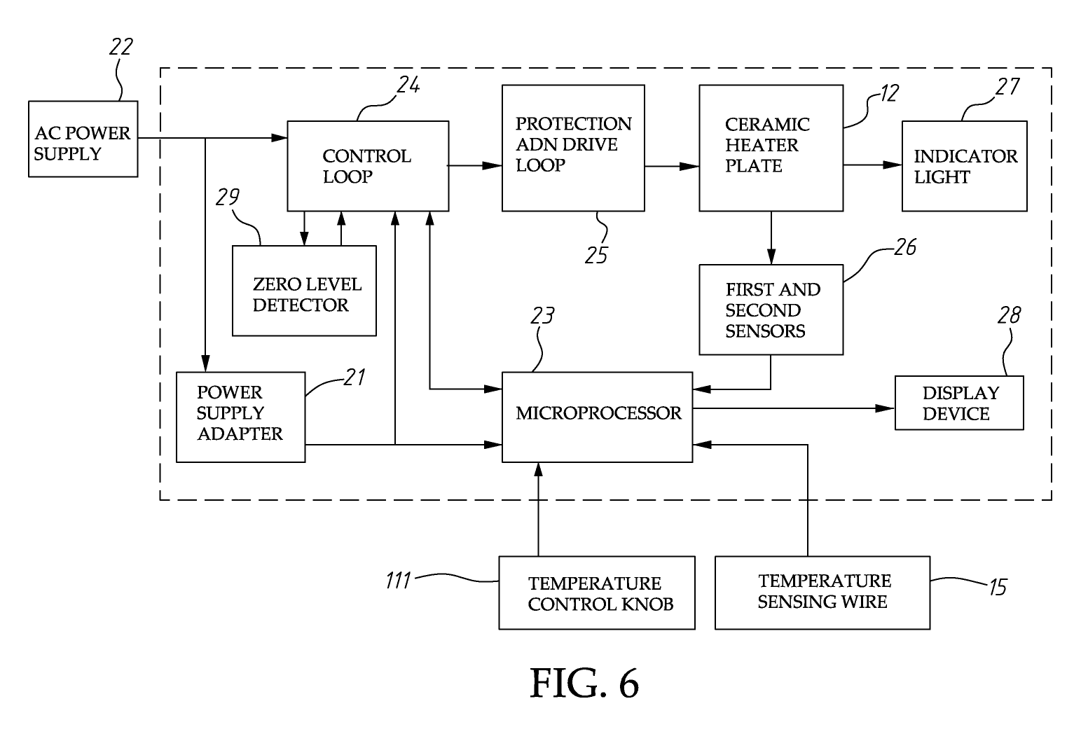

Referring to FIG. 6, the circuit controller 112 comprises a power supply adapter 21 electrically coupled to city AC power supply 22 and adapted for converting city AC power supply into the desired working voltage level for working, a microprocessor 23 electrically coupled with the temperature control knob 111 and the temperature sensing wire 15, a control loop 24 electrically coupled to the microprocessor 23, a protection and drive loop 25 electrically coupled to the control loop 24 and controlled by the microprocessor 23 through the control loop 24 to drive the ceramic heater plate 12 in generating heat subject to the set signal from the temperature control knob 111 and to turn off the ceramic heater plate 12 when the temperature sensing wire 15 detects an overheat temperature and outputs a corresponding signal to the microprocessor 23, first and second sensors 26 electrically coupled between the ceramic heater plate 12 and the microprocessor 12 for anti-knock control, and a zero level detector 29 electrically coupled to the control loop 24 for zero current detection, an indicator light 27 electrically coupled to the ceramic heater plate 12 for indicating the operation status of the ceramic heater plate 12, and a display device 28 electrically coupled to the microprocessor 23 and controlled by the microprocessor 23 to display operation data, such as temperature data, setting parameters and etc.

Obviously, the aquarium heater of the present invention has advantages as follows:

1. By means of using the ceramic heater plate 12 to generate heat and a circuit design to control adjustment of the heating temperature of the ceramic heater plate 12, the aquarium heater fits different sizes of aquariums, saving the cost.
2. The circuit design of the circuit controller 112 achieves anti-knocking control.
3. By means of using the ceramic heater plate 12 to generate heat, the invention can achieve transient heating, eliminating the slow heating drawback of the conventional designs.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. An aquarium heater, comprising:
a top cover carrying a temperature control knob at a top side thereof, a circuit controller at a bottom side thereof, and a power cord electrically coupled with said circuit controller and extending outside said top cover for power input, said temperature control knob being electrically coupled to said circuit controller for operation by a user to set one of a series of heating temperatures;
a ceramic heater plate arranged at the bottom side of said top cover and electrically coupled with said circuit controller and controllable by said circuit controller selectively to generate one of a series of watts of heat energy subject to setting of said temperature control knob;
a metal heat sink surrounding said ceramic heater plate; and
an insulative housing tightly attached to the bottom side of said top cover around said metal heat sink.

2. The aquarium heater as claimed in claim 1, wherein said circuit controller comprises a temperature sensing wire extending to the gap in between said ceramic heater plate and said metal heat sink for sensing a predetermined overheat temperature.

3. The aquarium heater as claimed in claim 2, wherein said circuit controller further comprises a power supply adapter electrically connected to city AC power supply and adapted for converting city AC power supply into the desired working voltage level for working, a microprocessor electrically coupled with said temperature control knob and said temperature sensing wire, and a control loop electrically coupled to said microprocessor, a protection and drive loop electrically coupled to said control loop and controlled by said microprocessor through said control loop to drive said ceramic heater plate in generating heat subject to the set signal from said temperature control knob and to turn off said ceramic heater plate when said temperature sensing wire detects an overheat temperature and outputs a corresponding signal to said microprocessor.

4. The aquarium heater as claimed in claim 3, wherein said circuit controller further comprises a first sensor and a second sensor electrically coupled between said ceramic heater plate and said microprocessor for anti-knock control.

5. The aquarium heater as claimed in claim 3, wherein said circuit controller further comprises an indicator light electrically coupled to said ceramic heater plate for indicating the operation status of said ceramic heater plate.

6. The aquarium heater as claimed in claim 3, wherein said circuit controller further comprises a display device electrically coupled to said microprocessor and controlled by said microprocessor to display operation-related data.

7. The aquarium heater as claimed in claim 3, wherein said circuit controller further comprises a zero level detector electrically coupled to said control loop for zero current detection.
